(19) United States
(12) Patent Application Publication
(10) Pub. No.: US 2015/0255782 A1
(43) Pub. Date: Sep. 10, 2015

(54) SEPARATION MEMBRANE FOR LITHIUM SULFUR BATTERIES

(71) Applicant: Hyundai Motor Company, Seoul (KR)

(72) Inventors: Tae Young Kim, Suwon (KR); Dong Hui Kim, Suwon (KR); Kyoung Han Ryu, Yongin (KR); Won Keun Kim, Suwon (KR)

(21) Appl. No.: 14/550,954

(22) Filed: Nov. 22, 2014

(30) Foreign Application Priority Data
Mar. 4, 2014 (KR) 10-2014-0025620

(51) Int. Cl. H01M 4/134; H01M 12/00; H01M 10/052; H01M 4/1395; H01M 4/04

(52) U.S. Cl. CPC H01M 4/134; H01M 4/1395; H01M 4/0416; H01M 4/0426; H01M 4/0419; H01M 4/0471; H01M 10/052; H01M 12/00; H01M 4/043

(57) ABSTRACT

Disclosed is a material which enhances stability for lithium in all the batteries, which use the lithium metal as an electrode material, by using and applying a lithium-substituted perfluoro sulfonic acid (PFSA) material in the form of a membrane or a powder to a lithium anode. Methods of manufacturing the material are also enclosed.

### CROSS-REFERENCE TO RELATED APPLICATION

This application claims under 35 U.S.C. §119(a) the benefit of Korean Patent Application No. 10-2014-0025620 filed on Mar. 4, 2014, the entire contents of which are incorporated herein by reference.

### TECHNICAL FIELD

The present invention relates to a material which may enhance stability for lithium in a battery, which use a lithium metal as an electrode material, by applying a lithium-substituted perfluoro sulfonic acid (Li-PFSA) material to the lithium anode. Methods of manufacturing the material for the battery are also disclosed.

### BACKGROUND

A secondary battery refers to a battery in which conversion between chemical energy and electrical energy reversibly occurs through chemical reactions of oxidation and reduction and charging and discharging are repeatedly performed. The secondary battery generally includes a positive electrode (cathode), a negative electrode (anode), a separation membrane and an electrolyte as basic components. An electrode refers to the cathode and the anode together, and among the elements of the electrode material, an active material causes the chemical reactions to produce electrical energy.

Among the secondary batteries, a lithium sulfur battery may have high energy density per the mass thereof, and the lithium sulfur battery has been highlighted as a candidate for a next-generation battery. The lithium sulfur battery uses a system which employs sulfur as a cathode active material and metallic lithium as an anode active material. Sulfur as a cathode active material may have a substantially high theoretical capacity of about 1 675 mAh/g, but the actual capacity thereof may be significantly reduced from the theoretical capacity due to various problems.

The major issue of the lithium sulfur battery may be a phenomenon in which sulfur diffuses from the electrolyte in the form of lithium-polysulfide (Li-PS) during charging and discharging reactions. When Li-PS, which diffuses from the electrolyte due to the reduction reaction, passes through the separation membrane and subsequently moves toward the anode, an unnecessary reaction may occur in the anode, and thus a charge delay may occur. This is referred to as a “Shuttle” phenomenon, and such a shuttle phenomenon may reduce the service life of the battery. Further, when the Li-PS moving toward the anode is reduced into Li₂S and Li₂S₂ to form a non-conductive material and deposited in the anode, the active material may be lost, thereby reducing the capacity of the battery.

The separation membrane used in the secondary battery serves to prevent a short-circuit between the anode and the cathode by passing lithium ions and the electrolyte while electrically insulating. Typically, a polyolefin-based separation membrane has been used, and Li ions may pass through pores present in the membrane, and simultaneously Li-PS may also pass.

In the related arts, researches have been focused on the application of the lithium anode membrane to prevent the Shuttle phenomenon by using and coating a polymer protective membrane on the lithium metal in the lithium sulfur battery to block the contact with lithium polysulfide and the lithium metal to suppress a side reaction with lithium.

However, in the currently used method, since the lithium polysulfide is only physically blocked and becomes a resistance at the interface, the lithium ion conductivity may be reduced. Further, the lithium ion battery which uses the lithium metal may also have various side reactions due to the use of the lithium metal and many disadvantages due to production of the SEI coating film.

In the related art, in an attempt to solve the aforementioned technical difficulties, an example of technologies related to the Li-PFSA membrane material has been reported (FIG. 2). In such technologies, since the movement of PS is blocked to suppress a side reaction with the Li anode, cell performance and service life may be enhanced. In addition, the active material may be prevented from being lost, thereby enhancing cell performance and service life. However, due to low lithium ion conductivity of the membrane material and limited increases in cell energy density and applications as a separation membrane, decreasing the thickness may not be obtained.

In other words, since the aforementioned technology in the related art is applied as a separation membrane rather than a concept of a protective film for the lithium anode, the thickness applied may be limited for preventing internal short-circuiting. As such, the technology in the related art may be similar to have the membrane composition in the present invention, but the roles thereof are significantly different from each other.

In another technology in the related art, lithium polymer secondary battery having cross-linked polymer protective thin film and method for manufacturing the same has been developed (FIG. 3). In this lithium polymer secondary battery, a cross-linked polymer protective thin film formed by crosslinking and polymerizing a cross-linkable acrylate-based precursor is formed on the surface of a lithium metal anode. Therefore, growth of dendritic lithium which may be generated on the surface of the lithium metal anode during the charge and discharge may be suppressed. In addition, uniformity of a passivation film formed by a repeated dissolution and precipitation reaction of lithium on the surface of the lithium metal anode may be obtained.

Furthermore, in the related art, a protective composition for anode of lithium sulfur battery and lithium sulfur battery fabricated by using same have been reported. As such, reactivity of the anode may be reduced and the surface may be stabilized by coating the cross-linkable anode protective film on the anode in the form of a thin film using a cross-linkable negative electrode protective composition, thereby enhancing the service life of the lithium sulfur battery.

In above cases, a side reaction may be suppressed by physically blocking the lithium metal and the electrolyte. However, lithium ions may not be selectively permeated and may become a resistance component, to thereby reduce lithium ion conductivity.

In other words, such technologies apply a polymer protective membrane for the purpose of controlling the reactivity of the lithium metal, but the protective layer actually may serve as a resistance element for lithium ions to pass through, and thus the lithium ion conductivity may be reduced.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides technical solutions to the aforementioned technical difficulties by applying a lithium-substituted PFSA membrane or a powder coating layer as a lithium protective film to the surface of the lithium metal, and further provide the protective film material which may enhance the lithium ion conductivity by supporting a channel through which lithium ions may pass. Provided are also method of manufacturing thereof.

In addition, for an all solid battery using lithium as an electrode, provided is a material which may use a solid electrolyte containing Ti, which has been used as a transition metal in the solid electrolyte composition, and has substantially increased lithium ion conductivity as compared to other solid electrolytes but reduced contact stability with the lithium metal.

Accordingly, the present invention provides a lithium metal protective film for enhancing stability for lithium in all the batteries that use the lithium metal as an electrode material by applying a lithium-substituted PFSA material to a lithium anode, either in the form of a membrane or in the form of a coating powder.

In one aspect, the present invention provides a method for manufacturing a battery which includes one or more of a counter electrode, a separation membrane and an electrolyte, a lithium metal, and a current collector, and uses lithium, the method including:

a) preparing a Li-PFSA polymer by substituting protons (H⁺) in a hydrogensulfide group (HSO₃) of a PFSA polymer of Formula 1 with Li⁺ ions; and

b) preparing a PFSA polymer protective film composite substituted with the lithium metal-lithium ion by applying the Li-PFSA polymer to the lithium metal.

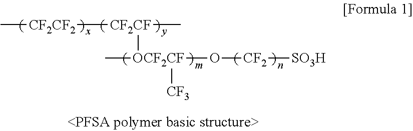

In Formula 1, m may be 0 or 1, n may be 0 to 5, x may be 0 to 15, and y may be 0 to 2. The equivalent weight of the PFSA polymer is of about 400 to 2000.

In certain embodiments, the PFSA polymer may be in a form of membrane or powder. When the PFSA polymer is a membrane, the substituted Li-PFSA polymer membrane may be bonded to the lithium metal. When the PFSA polymer is a powder, the substituted Li-PFSA polymer powder may be coated on the lithium metal.

The Li-PFSA polymer layer provided in the present invention may pass only lithium ions which may be from the lithium metal in all the batteries that use the lithium metal as an electrode material, thereby suppressing the growth of dendritic lithium which may be generated on the surface of a lithium metal anode during charging and discharging. Further, uniformity of a passivation film formed by repeated dissolution and precipitation reactions of lithium on the surface of the lithium metal anode may be obtained as advantages of a lithium protective film in the related art. Moreover, the capacity and service life of the battery may be significantly improved by reducing generation of internal resistance due to the protective layer, which is a disadvantage in the related art.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 schematically illustrates an exemplary battery to which a lithium-substituted perfluoro sulfonic acid polymer protective film is applied according to an exemplary embodiment of the present invention. A Li-PFSA polymer is bound to the surface of the lithium metal as an anode and used as a protective film;

FIG. 2 schematically illustrates a lithium-sulfur battery to which the Li-PFSA polymer is applied in the related art;

FIG. 3 schematically illustrates a lithium ion battery in which a lithium metal is used as an anode to which the protective film is applied in the related art;

FIG. 4 schematically illustrates an exemplary process of preparing a Li-ion substituted perfluoro sulfonic acid polymer membrane according to an exemplary embodiment of the present invention. The perfluoro sulfonic acid polymer is a polymer in which lithium ions are not originally present. According to an exemplary embodiment of the present invention, the Li-PFSA polymer may be prepared by substituting protons with lithium ions in the polymer. A conventional PFSA polymer membrane may be immersed in a solution containing LiOH and ethanol mixed at a weight ratio of 1:1 at a temperature of about 80° C. for about 12 hours or greater with stirring, as such lithium ions substituted PFSA polymer membrane (Li-PFSA) may be obtained. The substituted membrane may be washed with distilled water to remove residual salts and dried at a temperature of about 120° C. In another exemplary embodiment, the PFSA polymer may be a powder and Li-ion substitution may be performed as for the membrane;

FIGS. 5A TO 5B schematically illustrate exemplary methods of applying the Li-substituted PFSA polymer to the lithium metal as anode and an exemplary Li-substituted PFSA polymer is used as a protective film having a lithium ion path. In FIG. 5A, the lithium-substituted PFSA membrane may be placed on the lithium metal, and the membrane may be fixed by force when placing the membrane on the lithium metal and then laminating other parts thereon, or alternatively, an additional binder may be used according to an exemplary embodiment of the invention. In FIG. 5B, the lithium-substituted PFSA powder may be coated on the lithium metal by thermal spray method according to an exemplary embodiment of the present invention;

FIG. 6 perspectively illustrates an exemplary lithium ion battery to which a lithium-substituted PFSA polymer membrane is applied according to an exemplary embodiment of the present invention; and

FIG. 7 is a graph showing test results of an exemplary battery in FIG. 6 during charging and discharging. When the Li-PFSA membrane is applied, the service life of about 250 times may be achieved while the cell to which the related art is applied has the service life of about 100 times.

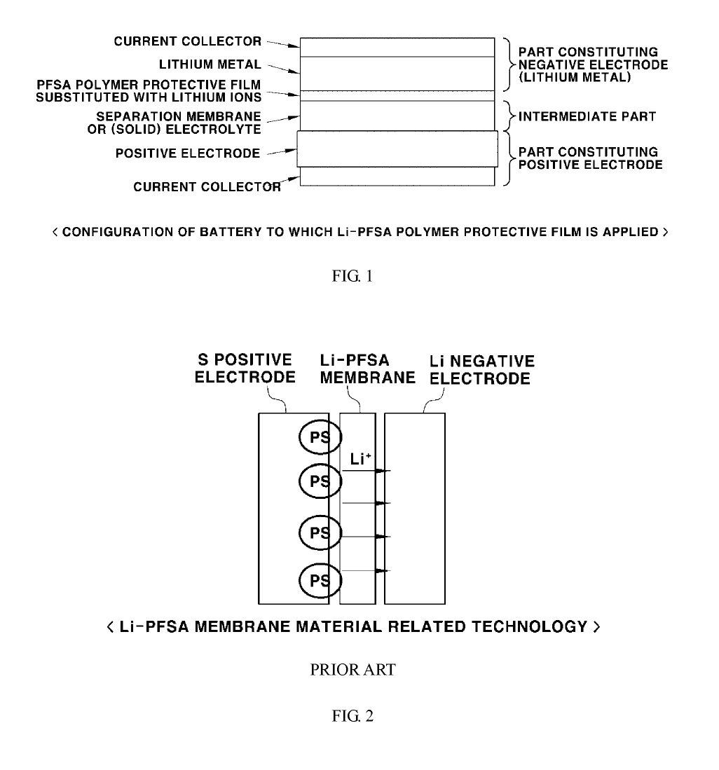

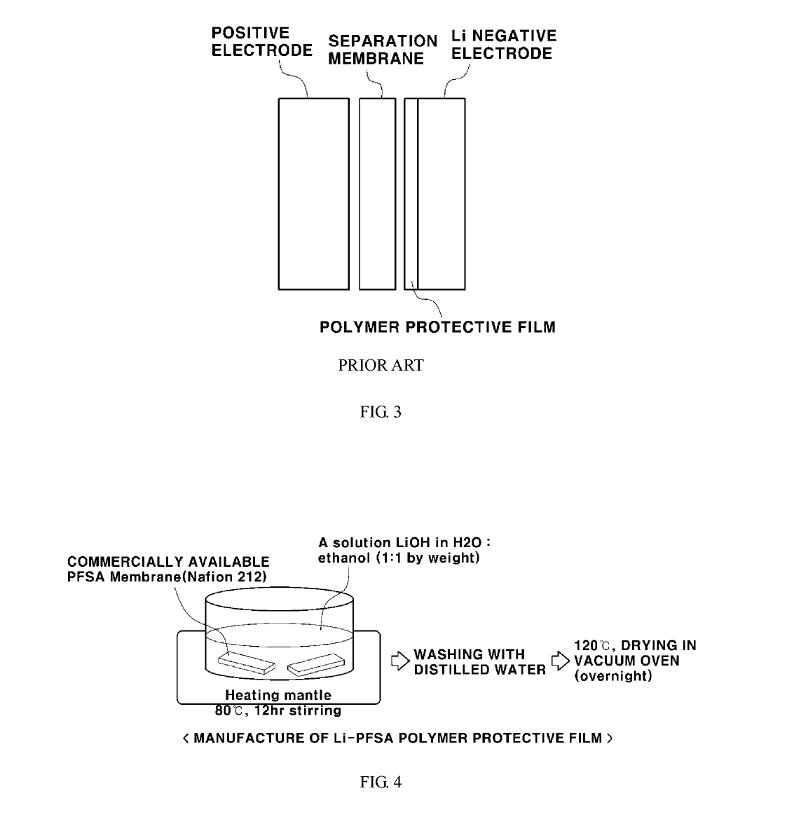

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one aspect, the present invention may be applied to all batteries using a lithium metal by coating a Li-PFSA polymer on the lithium metal or forming a layer on the lithium metal (FIG. 1). Particularly, the Li-PFSA polymer may pass lithium ions. Examples of batteries of the present invention may include, but not limited to, a lithium-sulfur battery, a lithium-air battery, a lithium metal battery, an all solid battery and the like. Accordingly, the Li-PFSA polymer may be applied to the exemplary batteries without limitation.

The lithium-sulfur battery, as used herein, is a battery in which a positive electrode is made of a sulfur active material, a conductive material and a binder, and a lithium metal is used as a negative electrode.

The lithium-air battery, as used herein, is a battery in which oxygen is used as a positive electrode, and a lithium metal is used as a negative electrode.

The lithium metal battery, as used herein, is a battery in which a lithium metal is used as a positive electrode or a negative electrode, and the counter electrode thereof is made of an active material including lithium.

The all solid battery, as used herein, is a battery in which a lithium metal is used as a positive electrode or a negative electrode, and the electrolyte is composed of a solid electrolyte such as oxide or sulfide.

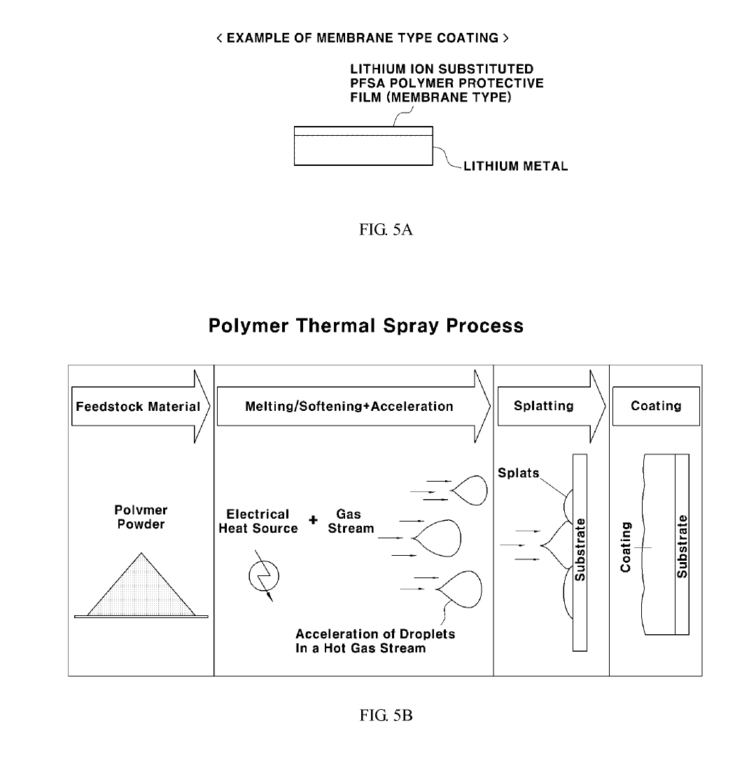

In another aspect, the present invention provides the method of manufacturing a lithium metal protective film (FIG. 4).

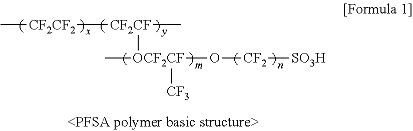

In certain embodiments, the PFSA membrane or the PFSA polymer powder may be substituted with Li ions. The PFSA polymer, as used herein, is a polymer including a —(CF₂CF₂)ₓ—(CF₂CF)_{y} backbone and a hydrogen sulfite (HSO₃⁻) group as a side chain. In certain exemplary embodiments of the present invention, protons (H⁺ ions) in the HSO₃⁻ group may be substituted with Li⁺ ions to form a Li-PFSA polymer.

In certain embodiments, the polymer may be a polymer film having an equivalent weight of about 400 to 2000, in which m is 0 or 1; n is 0 to 5; x is 0 to 2; and y is 0 to 2 in the Formula 1.

In certain embodiments, the polymer may be in a form of a membrane or a powder. In certain exemplary embodiments, as shown in FIG. 4, for substituting with Li ions in the membrane type polymer, the polymer membrane may be immersed in the solution including lithium ions for about 12 hours or greater, thereby forming the Li-PFSA membrane. In yet certain exemplary embodiment, a powder type polymer may be manufactured by immersing as the membrane type polymer as disclosed herein.

The substitution reaction in the polymer may be described as below.

SO₃H+LiOH→SO₃Li+H₂O

Subsequently, a PFSA polymer protective film composition may be prepared (FIG. 5A-5B). In certain exemplary embodiments, when using the membrane type, the substituted Li-PFSA membrane may be contacted with the surface of the Li metal (FIG. 5A). Particularly, the substituted Li-PFSA membrane may be placed on the lithium metal and fixed by pressure applied by other parts of the battery such as positive electrode, current collector and the like. Alternatively, the substituted Li-PFSA membrane may be adhered by a binder in which a small amount of PVDF may be used. In yet certain exemplary embodiments, when using the powder type, the Li-PFSA powder may be prepared in a solution, sprayed in the liquid state on the lithium metal and dried (FIG. 5B). Particularly, additional binder may not be used. In addition, when the powder form of Li-PFSA polymer is applied to manufacture a PFSA polymer protective film composite in the invention, conventional polymer coating methods in the art such as electrostatic coating or thermal spraying, sputtering, and dispersion coating may be used, thereby obtaining thin coating of the Li-PFSA polymer on the surface of the lithium metal. In certain exemplary embodiments, among the above coating methods, heating may be applied at a temperature of about 160° C. or less which is a temperature less than the melting point of the lithium metal or less, in order to prevent damage to the lithium metal.

Although the thinner coating layer may have the less resistance as a protective film, since durability may deteriorate with substantially reduced thickness, the thickness of the coated polymer layer in the present invention may be in a range from about 1 μm to about 20 μm, or particularly in a range from about 100 nm to about 100 μm.

In other aspect, the present invention provides various advantages. As such, by forming a Li-PFSA polymer layer which may pass only lithium ions on a lithium metal, growth of dendritic lithium which may be generated on the surface of a lithium metal anode during charge and discharge may be suppressed. In addition, the passivation film formed by repeated dissolution and precipitation reaction of lithium on the surface of the lithium metal anode may be obtained uniformly. Further, the capacity and service life of the battery may be significantly improved by reducing generation of internal resistance due to the protective layer, which is a disadvantage in the related art.

As such, 1) since the lithium ion conductivity is enhanced compared to that of the existing cross-linked polymer protective film, an internal resistance may be reduced and as consequence, the lithium ion conduction efficiency may be improved increased; 2) a material having a low contact stability with the lithium metal can be applied to the lithium metal compared to the case without the protective film, and thus, the high lithium ion conductive material may also be used, and the lithium ion conductivity may be further enhanced;

3) the cell service life may be enhanced since the electrolyte side reaction with the lithium anode or growth of the lithium dendrite may be suppressed compared to the case without the protective film lithium ion battery; and 4) the cell service life may also be enhanced since the lithium polysulfide shuttle may be prevented compared to the lithium sulfur battery without the protective film.

In Table, properties of conventional lithium metal protective film and an exemplary lithium metal protective film of the present invention are compared.

TABLE 1

| | Conventional lithium metal | lithium metal protective film |
|---|---|---|
| | protective film | in the present invention |
| Expected | Suppressing growth of lithium | Suppressing growth of lithium dendrite |
| effects | dendrite | Securing uniformity of passivation film |
| | Securing uniformity of | Reduction of internal resistance thereby |
| | passivation film | enhancing capacity and service life |
| | | A material having low contact stability |
| | | with lithium may be used. |
| Disadvantage | A protective film layer has | — |
| | resistance. | |
| | Large internal resistance | |

The present invention will be described with reference to the following exemplary examples in order to describe the present invention in more detail, and this is only an example of the present invention, and does not limit the range of the invention to be claimed by the specification. In particular, since the present example is an exemplary embodiment, the application of the present invention is not limited to a lithium ion battery.

### Example 1 of Li-PFSA Membrane-Type Lithium Metal Protective Film

### See FIG. 4

Protons (H⁺) in a commercially available PFSA polymer membrane are substituted with Li⁺ ions. A 1M LiOH aqueous solution and ethanol are prepared by mixing in a mass ratio of 1:1 by using Nafion 212 manufactured by Dupont Inc. in a beaker, and heated in a water bath while being stirred at a temperature of about 80° C. for about 12 hours or greater by using a heating mantle. When the higher the concentration of Li⁺ ions in the solution is, the easier the substitution of the membrane with Li may occur.

In the present Example, substitution of Li ions may be performed at a mass ratio of about 1:100 of the membrane and the solution. Salts remaining in the membrane after the substitution reaction are removed by washing the membrane with distilled water and dried overnight at a temperature of about 120° C. in a vacuum oven. The prepared Li ion substituted ionomer membrane polymer is stored in vacuum in a glove box.

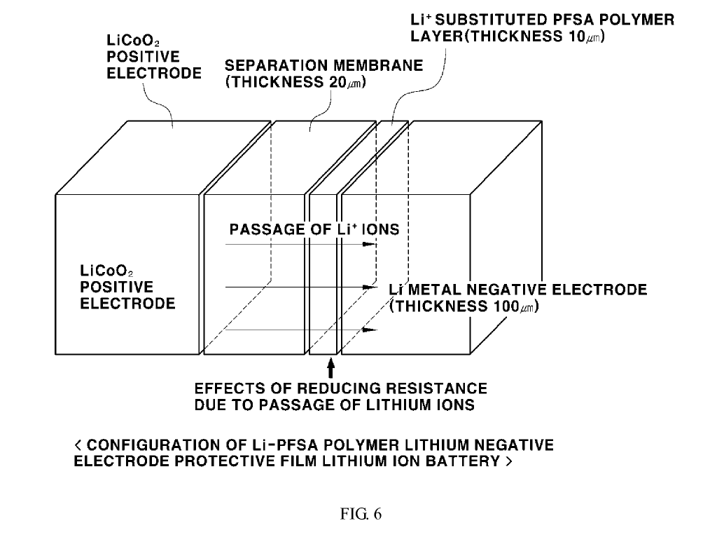

Further, a lithium ion coin cell-type battery is manufactured by applying the Li-PFSA polymer layer to the lithium metal (FIG. 6).

The cell is configured by using lithium cobalt oxide as a cathode active material, placing a separation membrane thereon, and binding the Li-PFSA polymer layer to the lithium metal anode and the cell is assembled by sequentially disposing the cathode, the separation membrane and the anode components. In an exemplary embodiment, for binding a Li-PFSA polymer membrane, the Li-PFSA polymer membrane is placed on the surface of the lithium metal and adhered thereto by force when other parts such as a separation membrane, a cathode and a spacer are laminated thereon.

In an exemplary embodiment, the discharge capacity per unit area of the cathode active material used may be about 5 mAh/cm², the discharge capacity per unit area of the anode lithium metal may be about 20 mAh/cm², and the electrolyte may have LiPF₆ of about 1 M with EC:EMC mass ratio of about 3:7.

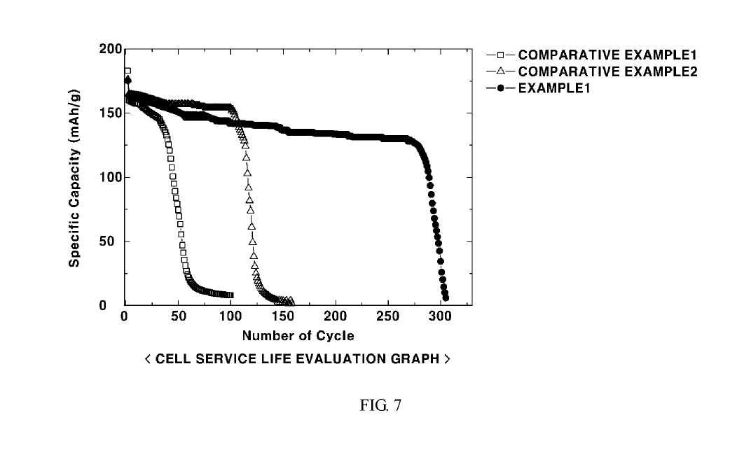

For the unit battery obtained in Example 1, a charging/discharging experiment is performed, and the number of cycles is confirmed when the residual capacity of each battery is of about 50% of the initial capacity. For the charging/discharging experiment, the first cycle is performed as a chemical synthesis step using a current density of C/10 based on the amount of filling lithium cobalt oxide as cathode active material of a unit battery manufactured at normal temperature. Subsequently, the charging/discharging experiment is performed by repeating a constant current—constant voltage charge (4.3 V cut-off) with a current density of about 2.5 mA/cm², which is a C/2 speed from the cycle and a constant current discharge of about 3.0 V cut-off, which is a C/2 speed form the cycle. The results are shown in the following Table 2 and FIG. 7.

TABLE 2

| | | Service life evaluation |
|---|---|---|
| | | Number of cycles |
| | | during 50% |
| | Cell conditions | residual capacity |
| Comparative | w/o protective film | 50 cycles |
| Example 1 | | |
| Comparative | Crosslinked polymer protective | 120 cycles |
| Example 2 | film | |
| Example 1 | Li-PFSA protective film | 300 cycles |

Discharge capacity per unit area of a cathode active material: about 5 mAh/cm²
Discharge capacity per unit area of an anode lithium metal (based on 100 μm): about 20 mAh/cm²

As shown in Table 2, the battery obtained in Example 1 has a 300 cycle in number of cycles during the residual capacity of about 50% of the initial capacity which is about 6 times higher than Comparative Example 1 and about 2.5 times higher than Comparative Example 2.

According to various exemplary embodiments, when the protective film of the present invention is applied, a substantially improved effect in service life characteristics may be obtained, and thus substantially improved performance may be obtained compared to the conventional protective film.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a battery which comprises one or more of a counter electrode, a separation membrane and an electrolyte, a lithium metal, and a current collector and uses lithium, comprising:
a) preparing a Li-PFSA polymer by substituting protons (H⁺) in a hydrogensulfide group (HSO₃) of a PFSA polymer of Formula 1 with Li⁺ ions; and
b) preparing a PFSA polymer protective film composite substituted with the lithium metal-lithium ion by applying the Li-PFSA polymer to the lithium metal: 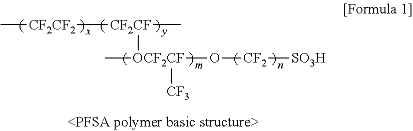
wherein in Formula 1, m=0 or 1, n=0 to 5, x=0 to 15, y=0 to 2, and an equivalent weight is of about 400 to 2000.

2. The method of claim 1, wherein the PFSA polymer is in a form of membrane or powder.

3. The method of claim 2, wherein in step b), the prepared Li-PFSA polymer membrane is bonded to the lithium metal.

4. The method of claim 2, wherein in step b), the prepared Li-PFSA polymer powder is coated on the lithium metal.

5. The method of claim 1, wherein in step a), the protons are substituted with lithium ions by immersing the PFSA polymer in a solution which contains lithium ions for about 12 hours to about 24 hours,
wherein a substitution reaction occurs as below,
SO₃H+LiOH→SO₃Li+H₂O.

6. The method of claim 1, wherein the battery which uses lithium is a lithium-sulfur battery, a lithium-air battery, a lithium metal battery or an all solid battery.

7. The method of claim 4, wherein the Li-PFSA polymer powder is coated on the lithium metal by electrostatic coating, thermal spraying, sputtering or dispersion coating.

8. The method of claim 7, wherein when heating is applied in the coating, the heating is performed at a temperature of about 160° C. or less or a melting point of the lithium metal or less.

9. The method of claim 1, wherein the PFSA polymer protective film composite has a thickness of about 100 nm to 100 μm.

10. The method of claim 9, wherein the PFSA polymer protective film composite layer has a thickness of about 1 μm to 20 μm.

11. A battery, comprising:
one or more of a counter electrode;
a separation membrane;
an electrolyte;
a lithium metal; and
a current collector,
wherein a Li-PFSA polymer is applied to the lithium metal, and
the Li-PFSA is prepared by substituting protons (H⁺) in a hydrogensulfide group (HSO₃) of a PFSA polymer in a hydrogensulfide group (HSO₃) of Formula 1 with Li⁺ ions 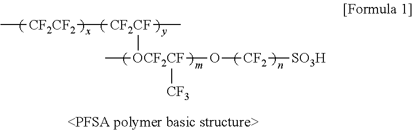
wherein in Formula 1, m=0 or 1, n=0 to 5, x=0 to 15, y=0 to 2, and an equivalent weight is 400 to 2000.

12. The battery of claim 11, wherein the PFSA polymer is in a form of membrane or powder.

13. The battery of claim 11, wherein the PFSA polymer is in the form of membrane and the prepared Li-PFSA polymer membrane is bonded to the lithium metal.

14. The battery of claim 11, wherein the PFSA polymer is in the form of powder and the prepared Li-PFSA polymer power is coated on the lithium metal.

15. The batter of claim 11, wherein the battery which uses lithium is a lithium-sulfur battery, a lithium-air battery, a lithium metal battery or an all solid battery.
